(19) United States
(12) Patent Application Publication
(10) Pub. No.: US 2011/0011370 A1
(43) Pub. Date: Jan. 20, 2011

(54) Air Pressure Vortex Generator Structure for an Internal Combustion Engine

(76) Inventor: Chang-Ho CHIEN, Shulin City (TW)

Correspondence Address: Muncy, Geissler, Olds & Lowe, PLLC, 4000 Legato Road, Suite 310, FAIRFAX, VA, 22033, US

(21) Appl. No.: 12/187,135

(22) Filed: Aug. 6, 2008

(51) Int. Cl. F02B 31/00

(52) U.S. Cl. 123/306

(57) ABSTRACT

An air pressure vortex generator structure for an internal combustion engine, which is installed within an intake manifold between an air filter and an internal combustion engine, and primarily comprises a tubular body, one end of which has a plurality of guide plates inwardly or outwardly bent from a tube wall thereof, The guide plates are arranged to be equally spaced, and are inclined in the same direction. Accordingly, when in use, functionality of each of the guide plates is used to cause air passing through a vortex generator to naturally form a plurality of spiral air currents that are propelled forward at an accelerated speed, which enable achieving thorough and uniform mixing with fuel, thereby causing complete combustion of the fuel to produce maximum horsepower and torque, as well as achieving the objective to save fuel.

### BACKGROUND OF THE INVENTION

(a) Field of the Invention

The present invention relates to an air pressure vortex generator structure for an internal combustion engine, and more particularly to a vortex generator structure able to cause air entering an internal combustion engine to naturally form a plurality of spiral type air currents, accelerating the velocity of flow of air entering the internal combustion engine, and enabling thorough uniform mixing of the air and fuel and complete combustion thereof, thereby enabling each portion of fuel to produce maximum power, and further achieving the effectiveness to increase horsepower while saving fuel.

(b) Description of the Prior Art

When using an internal combustion engine (comprising a carburetor or jet type internal combustion engine) of the prior art, an adequate supply of air must enter the engine and thoroughly mixed with the fuel in order to cause effective combustion of the fuel and produce a driving torque; and the more complete the combustion is, the larger the torque produced (that is, the larger the horsepower is), and the greater the savings on fuel, while at the same time can also increase the serviceable life of each part of the internal combustion engine, including the ignition system, the air valve, the cylinder heads, and so on. Otherwise, torque will be inadequate and fuel will be wasted, causing air pollution and easily causing problems of knocking combustion, carbon deposition and impeded ignition.

Hence, there are intake manifolds on the current market which enable better unimpeded intake of air into an internal combustion engine, and an air supercharger is installed within the intake manifold. However, the structures of prior art air superchargers all have a rotatable blade or turbine that can be fitted within the intake manifold or within a tubular body connected thereto, and the blade or turbine is caused to rotate when an air current passes through, thereby producing a thrust force that increases forward movement of the air current, with the expectation of achieving the anticipated effectiveness and objective. Nevertheless, shortcomings of the aforementioned prior art structures include: structure of the installed rotatable blade or turbine is complicated, high cost, and fixed parts, including supports or rotating shaft structures, and the like, easily impede air circulation. Therefore, such prior art structures can only achieve limited effectiveness, and not of economic benefit.

### SUMMARY OF THE INVENTION

Hence, in light of the shortcomings of the aforementioned air supercharger structure for an internal combustion engine of the prior art when in actual use, including low effectiveness and high cost of the structure, the inventor of the present invention, having accumulated years of experience in the design and manufacturing of related products, has meticulously carried out extensive study and exploration to ultimately design a new improved air pressure vortex generator structure for an internal combustion engine.

A primary objective of the present invention is to provide an air pressure vortex generator structure for an internal combustion engine, which does not have any rotating parts, has a simple structure, low cost, and causes air entering an internal combustion engine to naturally produce spiraling air current supercharging and turbulence effectiveness, enabling thorough and uniform mixing of the air with fuel, and thereby enabling more complete combustion to produce maximum horsepower and torque, as well as achieving the objective of saving fuel.

In order to achieve the aforementioned objective, the air pressure vortex generator structure for an internal combustion engine of the present invention primarily comprises a plurality of guide plates inwardly bent from a tube wall at one end of a tubular body, and the guide plates are arranged to be equally spaced, and are inclined in the same direction.

According to the aforementioned structure, when installed within an intake manifold between an automobile air filter and an internal combustion engine and in use, then functionality of each of the guide plates is used to cause air passing through a vortex generator to naturally form a plurality of spiral air currents that are propelled forward at an accelerated speed, which enable achieving thorough and uniform mixing with fuel, and further enabling complete combustion of the fuel to produce maximum horsepower and torque, as well as achieving the objective to save fuel.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational view depicting an embodiment of an air vortex generator structure according to the present invention.

FIG. 2 is a plane bottom view of the embodiment of FIG. 1.

FIG. 3 is an elevational view depicting another embodiment of the air vortex generator structure according to the present invention.

FIG. 4 is a plane bottom view depicting an elliptical shaped tubular body of FIG. 1 and FIG. 3 of the present invention.

FIG. 5 is a plane bottom view depicting a rectangular shaped tubular body of FIG. 1 and FIG. 3 of the present invention.

FIG. 6 is an implementation schematic view of the present invention installed within an air manifold.

FIG. 6A is an enlarged implementation schematic view of the present invention installed within an air manifold.

FIG. 7 is an elevational view depicting yet another embodiment of the air vortex generator structure according to the present invention.

FIG. 8 is a plane bottom view of the embodiment of FIG. 7.

FIG. 9 is an elevational view depicting yet another embodiment of the air vortex generator structure according to the present invention.

### DETAILED DESCRIPTION OF THE PREFERRED EMBODIMENTS

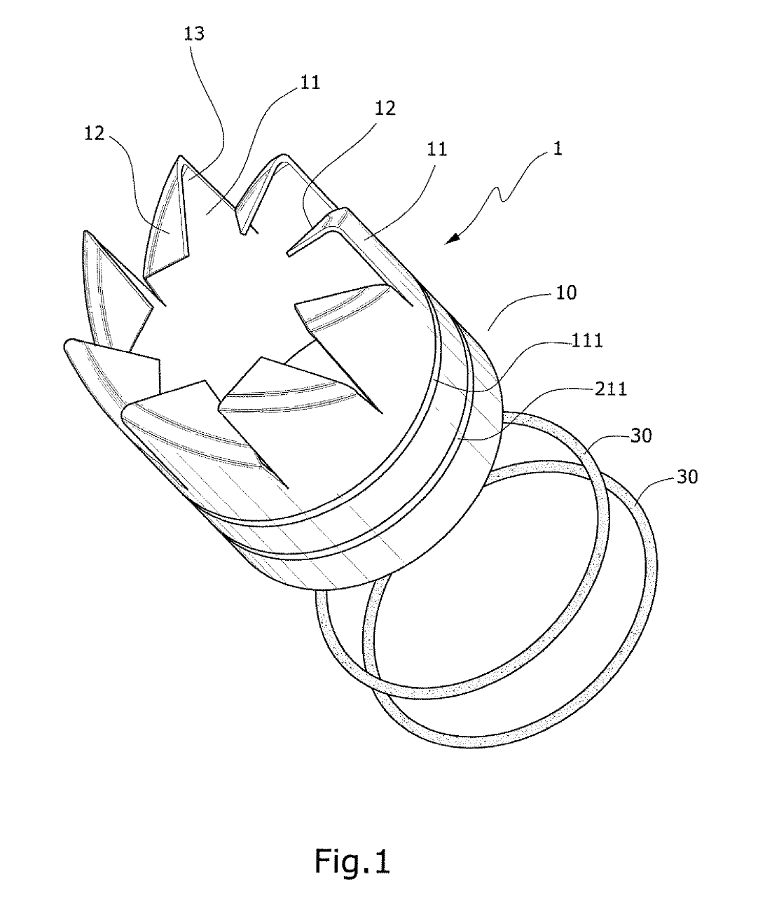

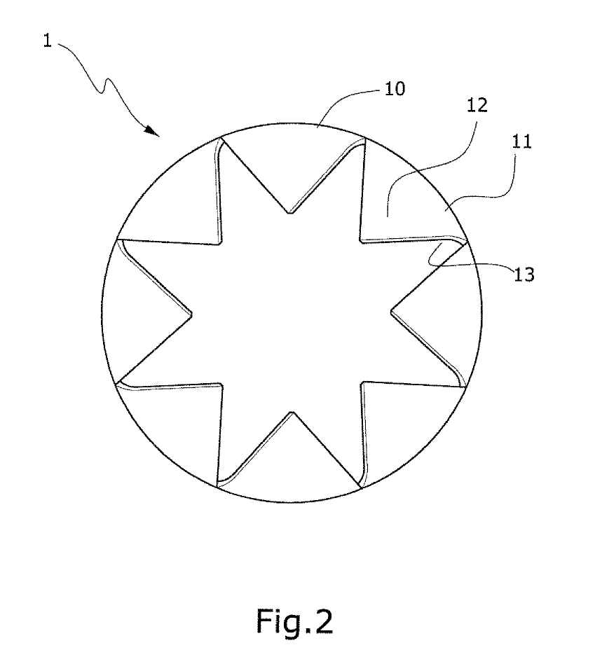

Referring first to FIG. 1 and FIG. 2, which show an embodiment of a structure of an air pressure vortex generator 1 for an internal combustion engine, primarily comprising a plurality of guide plates 12 inwardly bent from a tube wall 11 at one end of a tubular body 10, and an included angle between a rear end of each of the guide plates 12 and the tube wall 11 forms a air-guide spout 13. The guide plates 12 are arranged to be equally spaced, and are inclined in the same direction (when actualizing the present invention, the guide plates 12 can be inclined towards the left or inclined towards the right).

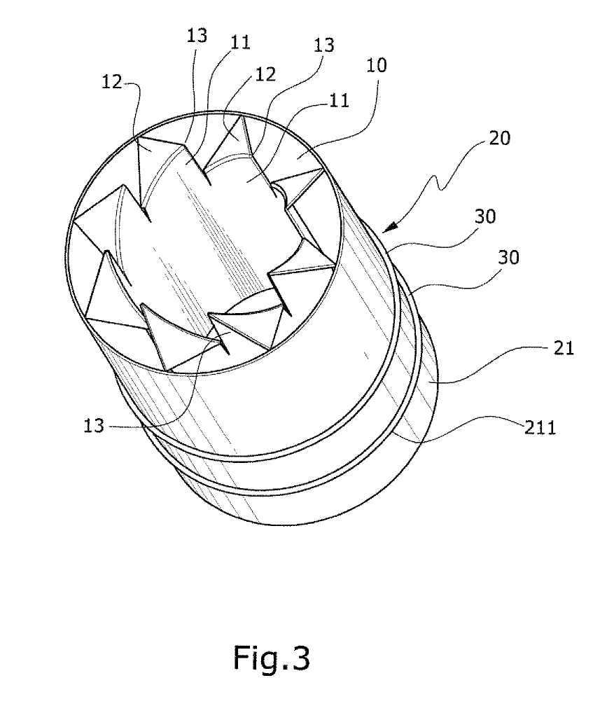

Referring to FIG. 3, which shows another embodiment of the present invention, in which a plurality of the guide plates 12 are outwardly bent from the tube wall 11 at one end of the tubular body 10. The guide plates 12 are similarly arranged to be equally spaced, and are inclined in the same direction. Moreover, an identical shaped outer tube 20 is circumferentially located on an outer edge formed by the plurality of guide plates 12. Accordingly, covering by the outer tube 20 enables facilitating sleeve joining to an air manifold.

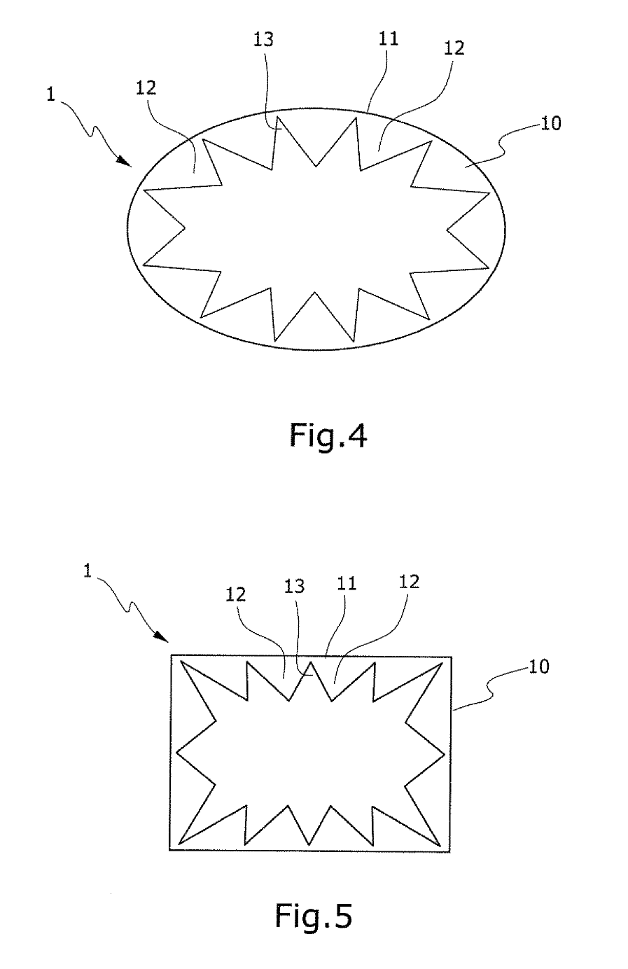

External appearance of the aforementioned tubular body 10 can be circular (as depicted in FIG. 1 and FIG. 3), or can be elliptical, as depicted in FIG. 4, or can be rectangular, as depicted in FIG. 5, or can be other polygonal in shape (not shown in the drawings). An outer side of the tube wall 11 of the tubular body 10 or a tube wall 21 of the outer tube 20 depicted in the embodiment of FIG. 3 can be configured with grooves 111, 211 (as depicted in FIG. 1 and FIGS. 3), and O-shaped rings 30 are respectively fitted into the grooves 111, 211. The O-shaped rings 30 are used to lodge to the inside of the air manifold, and can be adjusted or diameter of the O-shaped rings 30 changed to accommodate the internal diameter of various branded air manifolds, thereby reducing the cost of preparatory materials and improving use effectiveness and economic value of the product.

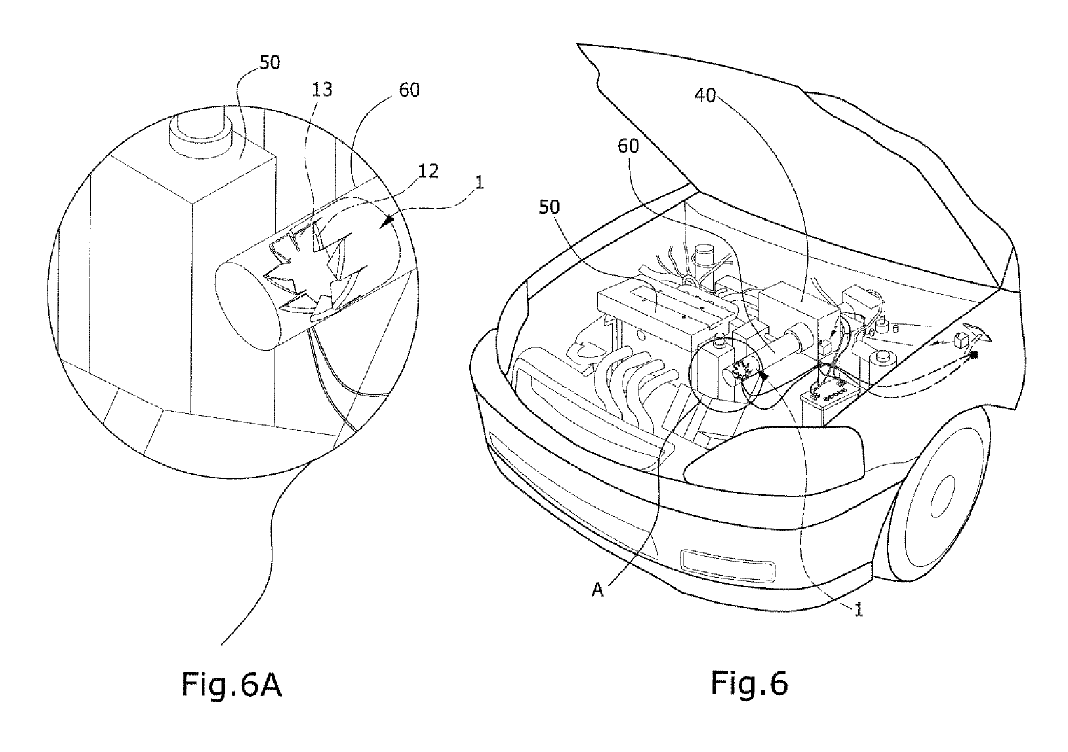

According to the aforementioned structure, and in conjunction with FIG. 6 and FIG. 6A, when the vortex generator 1 structure of the present invention is installed within an intake manifold 60 between an automobile air filter 40 and an internal combustion engine 50 (for example, installed close to one end of an air filter or close to one end of a carburetor of an internal combustion engine) and in use, then functionality of each of the guide plates 12 is used to cause air passing through the vortex generator 1 to naturally form a spiral air current at each of the air-guide spouts 13 at the rear end of each of the guide plates 12 that is propelled forward at an accelerated speed. Apart from enabling increasing the velocity of flow of the air currents towards the internal combustion engine 50, moreover, the guide plates 12 cause reciprocal interaction between the air currents to form impact and agitation phenomena, which enable achieving thorough agitation and uniform mixing effectiveness when the air is mixed with fuel, and further enabling complete combustion of the fuel within the combustion chambers, thereby enabling the internal combustion engine 50 to produce maximum output torque and increase engine horsepower, as well as effectively achieving the objective and effectiveness to save fuel.

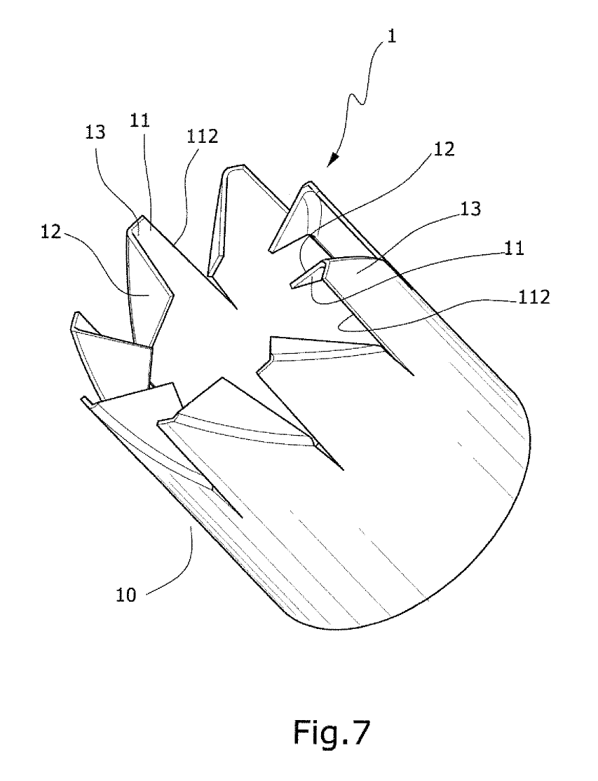

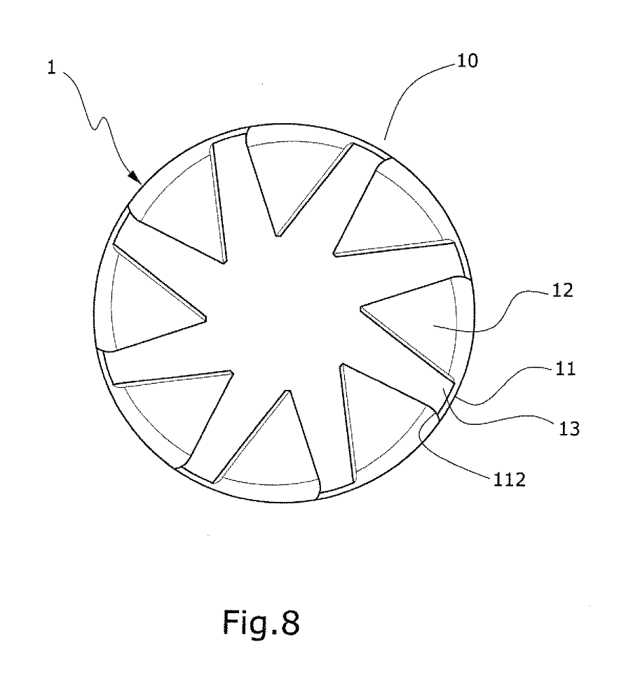

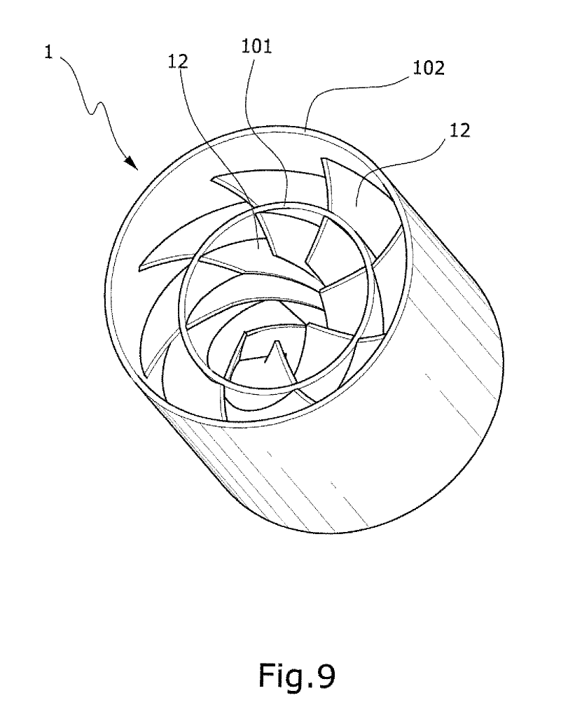

According to the aforementioned structure, and in conjunction with FIG. 7 and FIG. 8, which show another embodiment of the present invention, wherein the air-guide spouts 13 are formed between the guide plates 12 and the tube walls 11, and a space is retained between each side edge surface 112 of the tube wall 11 and the air-guide spouts 13. Accordingly, when using the embodiment structure, a different directional air current is formed between each side edge surface 112 of the tube wall 11 and the air-guide spouts 13, thereby causing the air agitation phenomenon to be more acute, and more clearly displaying the effectiveness and objective described in the present invention.

According to the aforementioned structure, and in conjunction with FIG, 9, which shows another embodiment of the present invention, wherein the embodiment is a structure formed by injection molding of plastic material, and is provided with two coaxially disposed large and small tubular bodies 101 and 102; moreover, a plurality of the guide plates 12 are respectively provided on inner wall surfaces of the two pipe bodies 101 and 102, thereby enabling such a device to increase sectional area causing turbulent flow, and providing the effectiveness of double turbulence. Furthermore, the aforementioned guide plates 12 can be rectangular shaped, triangular shaped, or triangular shaped provided with cambered surfaces, and configurational direction of inclination of each of the guide plates 12 within the two tubular bodies 101 and 102 can be the same direction or different directions.

In conclusion, the air pressure vortex generator structure for an internal combustion engine of the present invention is clearly a simple structure which does not have any rotating parts, and does not require power while causing air entering an internal combustion engine to naturally form spiral air currents to allow thorough mixing with fuel, thereby achieving strengthening horsepower and torque, as well as achieving the effectiveness to save fuel. Moreover, prior to this application, products having a similar structure to that of the present invention have not been seen in publications or in public use, thus complying with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An air pressure vortex generator structure for an internal combustion engine, comprising a tubular body, a plurality of guide plates are inwardly bent from a tube wall at one end of the tubular body, and an included angle between a rear end of each of the guide plates and the tube wall forms a air-guide spout; the guide plates are arranged to be equally spaced, and are inclined in the same direction.

2. The air pressure vortex generator structure for an internal combustion engine according to claim 1, wherein external appearance of the tubular body is circular, elliptical, rectangular, or polygonal in shape.

3. The air pressure vortex generator structure for an internal combustion engine according to claim 1, wherein grooves are defined in an outer side of the tube wall of the tubular body, and O-shaped rings are externally fitted in the grooves.

4. The air pressure vortex generator structure for an internal combustion engine according to claim 1, wherein a space is retained between each side edge surface of the tube wall and the air-guide spout.
